(19) United States
(12) Patent Application Publication
(10) Pub. No.: US 2026/0161178 A1
(43) Pub. Date: Jun. 11, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: KENTA NAKASHIMA, TOKYO (JP); NAOKI UCHIDA, TOKYO (JP)

(21) Appl. No.: 19/123,118

(22) PCT Filed: Oct. 10, 2023
(86) PCT No.: PCT/JP2023/036674

§ 371 Date: Apr. 22, 2025

(30) Foreign Application Priority Data
Oct. 28, 2022 (JP) 2022-173133

(51) Int. Cl. G05D 1/646; G05D 1/246; G05D 101/15; G05D 109/10; G05D 111/10; G05D 111/20; G05D 111/30

(52) U.S. Cl. CPC G05D 1/646; G05D 1/246; G05D 2101/15; G05D 2109/10; G05D 2111/10; G05D 2111/20; G05D 2111/30

(57) ABSTRACT

The present disclosure relates to an information processing apparatus, an information processing method, and a program that enable a mobile body such as a self-propelled robot including a sensor to efficiently search for three-dimensional spatial information in an unknown space.

A plurality of surrounding posture observation three-dimensional terrains detected in a plurality of surrounding postures in which at least one of a position or a direction is different by a predetermined value from an initial posture is estimated on the basis of an initial posture observation three-dimensional terrain detected in a sensor of a mobile body in the initial posture, a terrain around the mobile body is estimated as a surrounding terrain for each of the initial posture observation three-dimensional terrain and the plurality of surrounding posture observation three-dimensional terrains together with reliability, and when the reliability of an initial posture surrounding terrain estimated from the initial posture observation three-dimensional terrain is the highest, a route and a posture of the mobile body starting from the initial posture are planned and movement is controlled. The present invention can be applied to an autonomously traveling robot including a sensor.

### TECHNICAL FIELD

The present disclosure relates to an information processing apparatus, an information processing method, and a program, and more particularly, to an information processing apparatus, an information processing method, and a program capable of efficiently searching for three-dimensional spatial information in an unknown space by a mobile body such as a self-propelled robot including a sensor.

### BACKGROUND ART

In using a mobile body such as a self-propelled robot, in order for a user to grasp an operating environment of the mobile body and instruct an operation, a technology for creating an environment model of a surrounding operating environment including three-dimensional spatial information using sensing information of a sensor provided in the mobile body has been developed.

In this technology, basically, an environment model of a surrounding operating environment including three-dimensional spatial information is constructed by a user's operation (non-autonomous), or a preliminary plan is made for a known environment, and a mobile body moves on the basis of the preliminary plan, thereby performing a search for constructing an environment model of a surrounding operating environment.

For this reason, it is desired that a mobile body including a robot autonomously efficiently searches for an unknown environment and constructs an environment model of a surrounding operating environment including three-dimensional spatial information.

However, there is a limit to the sensing information obtained at the initial position of the robot, and the sensing information includes an occlusion region and an unknown region. Therefore, it has not been possible to efficiently search a surrounding unknown space and generate an environment model including three-dimensional spatial information.

Therefore, a technique for inferring an operating environment of an occlusion region or an unknown region has been proposed (see Patent Document 1).

### CITATION LIST

### Patent Document

Patent Document 1: Japanese Patent Application Laid-Open No. 2017-182434

### SUMMARY OF THE INVENTION

### Problems to be Solved by the Invention

However, also in the technology of Patent Document 1, since the inference accuracy of the operating environment of the occlusion region or the unknown region depends on the initial posture, sufficient inference cannot be performed depending on the initial posture, and there is a possibility that the surrounding operating environment cannot be efficiently searched to generate the environment model.

The present disclosure has been made in view of such a situation, and particularly, an object of the present disclosure is to enable a self-propelled robot including a sensor to efficiently acquire a surrounding operating environment including three-dimensional spatial information in an unknown space.

### Solutions to Problems

An information processing apparatus and a program according to one aspect of the present disclosure are an information processing apparatus and a program including: a surrounding posture observation three-dimensional terrain estimation unit that estimates a plurality of surrounding posture observation three-dimensional terrains around a mobile body detected by a sensor of the mobile body in a plurality of surrounding postures in which at least one of a position or a direction is different by a predetermined value from an initial posture on the basis of an initial posture observation three-dimensional terrain around the mobile body detected by the sensor of the mobile body in the initial posture; a surrounding terrain estimation unit that estimates a terrain around the mobile body as a surrounding terrain on the basis of the initial posture observation three-dimensional terrain and each of the plurality of surrounding posture observation three-dimensional terrains; and a control unit that plans a route and a posture of the mobile body and controls movement on the basis of the surrounding terrain estimated by the surrounding terrain estimation unit.

An information processing method according to one aspect of the present disclosure is an information processing method including the steps of: estimating a plurality of surrounding posture observation three-dimensional terrains around a mobile body detected by a sensor of the mobile body in a plurality of surrounding postures in which at least one of a position or a direction is different by a predetermined value from an initial posture on the basis of an initial posture observation three-dimensional terrain around the mobile body detected by the sensor of the mobile body in the initial posture; estimating a terrain around the mobile body as a surrounding terrain on the basis of the initial posture observation three-dimensional terrain and each of the plurality of surrounding posture observation three-dimensional terrains; and planning a route and a posture of the mobile body and controlling movement on the basis of the surrounding terrain estimated.

In one aspect of the present disclosure, a plurality of surrounding posture observation three-dimensional terrains around a mobile body detected by a sensor of the mobile body in a plurality of surrounding postures in which at least one of a position or a direction is different by a predetermined value from an initial posture is estimated on the basis of an initial posture observation three-dimensional terrain around the mobile body detected by the sensor of the mobile body in the initial posture, a terrain around the mobile body is estimated as a surrounding terrain on the basis of the initial posture observation three-dimensional terrain and each of the plurality of surrounding posture observation three-dimensional terrains, and a route and a posture of the mobile body are planned and movement is controlled on the basis of the surrounding terrain estimated.

### BRIEF DESCRIPTION OF DRAWINGS

FIG. 1 is a diagram for explaining a movement route planned in a case where obstacle are known.

FIG. 2 is a diagram for explaining a movement route planned only from a sensing result of a sensor.

FIG. 3 is a diagram for explaining a movement route planned on the basis of obstacles inferred from a sensing result.

FIG. 4 is a diagram for explaining respective sensing results of an initial posture and surrounding postures.

FIG. 5 is a diagram for explaining an estimation result of a surrounding terrain in each of an initial posture and surrounding postures according to the present disclosure.

FIG. 6 is a diagram for explaining a configuration example of a mobile body of the present disclosure.

FIG. 7 is a diagram for explaining a configuration example of an inference unit in FIG. 6.

FIG. 8 is a diagram for explaining an example of an observation 3D terrain in an initial posture, an observation 3D terrain in a surrounding posture based on the observation 3D terrain in the initial posture, and respective complementary maps.

FIG. 9 is a diagram for explaining an example of a UI image that presents reliability of a complementary map in each of an initial posture and surrounding postures.

FIG. 10 is a diagram for explaining an example of a UI image displayed when the position/posture mark MPL of FIG. 9 is selected.

FIG. 11 is a diagram for explaining an example of a UI image displayed when the position/posture mark MPR in FIG. 9 is selected.

FIG. 12 is a diagram for explaining another example of a UI image that presents reliability of a complementary map in each of an initial posture and surrounding postures.

FIG. 13 is a diagram for explaining an example of enlarged display of a UI image that presents reliability of a complementary map in each of an initial posture and surrounding postures in a dotted frame in FIG. 12.

FIG. 14 is a flowchart for explaining a drive control process.

FIG. 15 is a flowchart for explaining initial posture determination processing (part 1) in FIG. 14.

FIG. 16 is a flowchart for explaining initial posture determination processing (part 2) in FIG. 14.

FIG. 17 illustrates a configuration example of a general-purpose computer.

### MODE FOR CARRYING OUT THE INVENTION

Hereinafter, preferred embodiments of the present disclosure will be described in detail with reference to the accompanying drawings. Note that, in the present specification and the drawings, components having substantially the same functional configuration are denoted by the same reference signs, and redundant description is omitted.

Hereinafter, modes for carrying out the present technology will be described. The description will be given in the following order.
1. Overview of Present Disclosure
2. Preferred Embodiments
3. Example Executed by Software

### 1. Overview of Present Disclosure

In particular, the present disclosure enables a mobile body such as a self-propelled robot including a sensor to efficiently acquire three-dimensional spatial information in an unknown space.

In a case where it is attempted to construct an environment model of a surrounding operating environment including three-dimensional spatial information in an unknown space by a mobile body including a self-propelled robot provided with a sensor, it is necessary to comprehensively sense a real space.

Therefore, in order to autonomously perform comprehensive sensing of the real space by the robot, a movement plan and a posture plan for comprehensively directing sensors with a limited angle of view toward the real space are required in order to acquire sensor data necessary for constructing an environment model of a surrounding operating environment including three-dimensional spatial information.

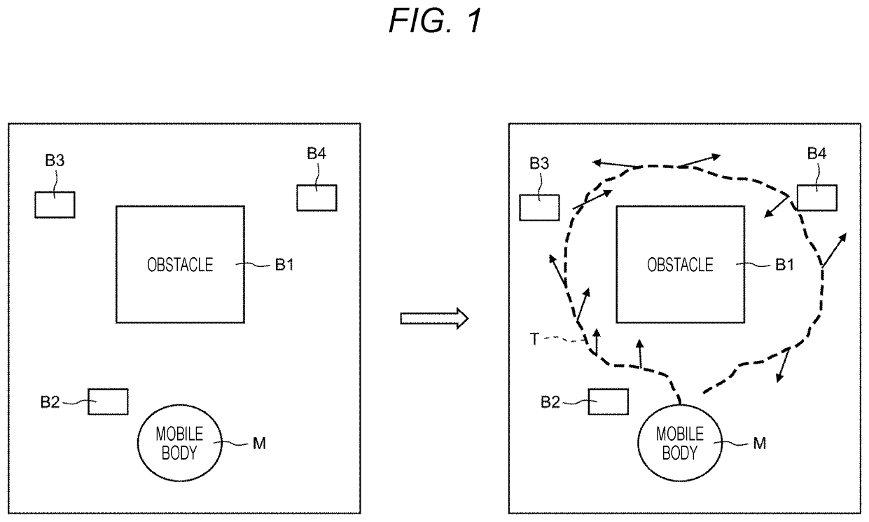

For example, a case where a three-dimensional space in which a mobile body M including a robot including a sensor is present is present in a space in which obstacles B1 to B4 as illustrated in the left part of FIG. 1 is considered.

In order to efficiently direct the provided sensor while the mobile body M autonomously and efficiently moves in the three-dimensional space as illustrated in the left part of FIG. 1, for example, a route plan such as a route T indicated by a dotted line as illustrated in the right part of FIG. 1 and a posture plan indicating a direction to be directed by the sensor indicated by arrows are required.

However, here, since the real space to be targeted is an unknown space, the mobile body M cannot make a route plan or a posture plan in advance.

Furthermore, in a case where a search is performed only with instantaneous data that can be acquired by the sensor in the initial posture without making a prior route plan or posture plan, it is not possible to know from the sensor data how the destination of occlusion or the like is.

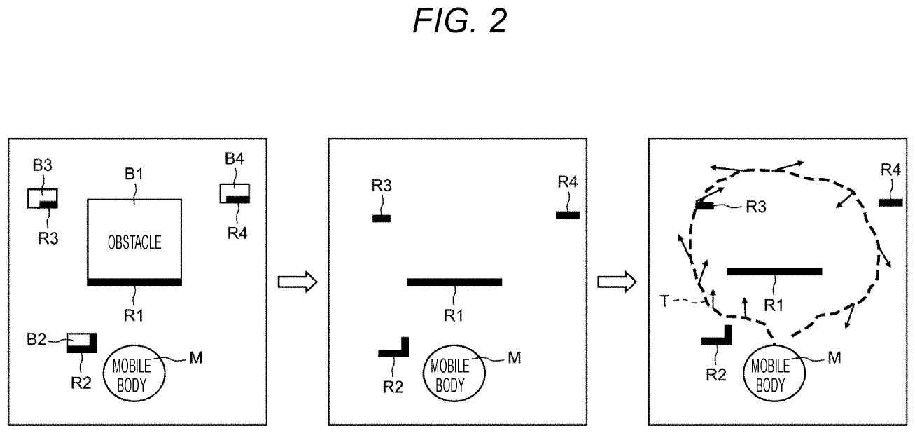

That is, as illustrated in the left part of FIG. 2, even if the mobile body M senses the obstacles B1 to B4 by its own sensor, the information obtained therefrom is only the information in the field of view of the sensor provided in the mobile body M among the respective surfaces, and is, for example, the observation 3D terrains R1 to R4 including a part of the surfaces of the obstacles B1 to B4.

Therefore, the information obtained by the mobile body M only from the observation 3D terrains R1 to R4 is only very little information in the three-dimensional space as illustrated in the central part of FIG. 2, and the destinations of unknown regions and occlusion regions other than the observation 3D terrains R1 to R4 are unknown.

The mobile body M cannot implement the route plan and the posture plan as illustrated in the right part of FIG. 2 in the initial posture.

If it is attempted to autonomously implement the search from this state, it is necessary to repeat an operation of moving to a position where occlusion is eliminated, and it is difficult to perform an efficient search, and it is also difficult to implement a global search which is a global search plan.

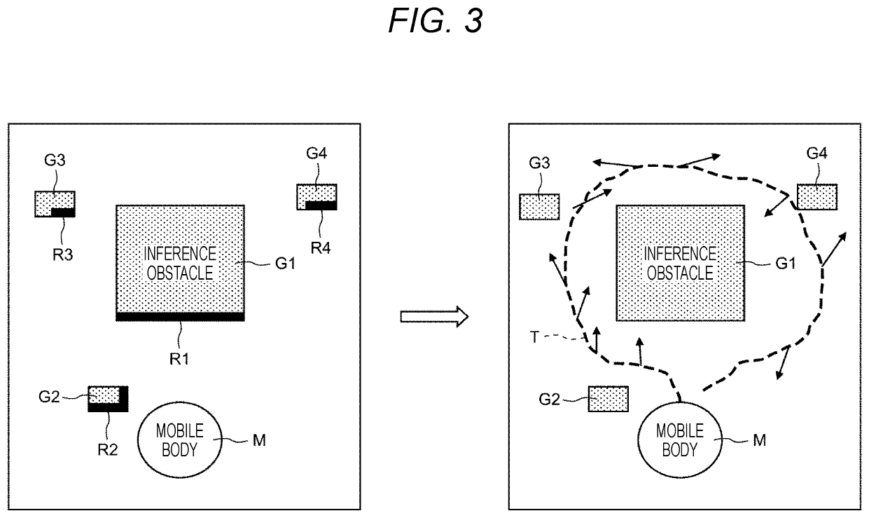

Therefore, as illustrated in the left part of FIG. 3, it is conceivable to infer inference obstacles G1 to G4 corresponding to the obstacles B1 to B4 from the information of the observation 3D terrains R1 to R4 that can be acquired by the mobile body M, and to implement a route plan indicated by a route T as illustrated in the right part of FIG. 3 and a posture plan indicated by arrows on the basis of the inference obstacles G1 to G4 which are the inference results.

However, in the information of the observation 3D terrains R1 to R4 that can be acquired by the mobile body M in the initial posture, the information covered is not sufficient in order to appropriately infer the inference obstacles G1 to G4 corresponding to the obstacles B1 to B4, and it is difficult to infer with predetermined accuracy.

### Surrounding Posture With Respect to Initial Posture

Therefore, in the present disclosure, a model that infers (estimates) the observation 3D terrain in the surrounding posture slightly different from the initial posture is introduced on the basis of the observation 3D terrains R1 to R4 that can be acquired from the mobile body M in the initial posture, and an efficient search is implemented using the inference obstacle based on the observation 3D terrain in the surrounding posture and its reliability.

Note that, in the present disclosure, the posture of the mobile body M includes information on the position of the mobile body M in the three-dimensional space and information on the direction in which the sensor provided in the mobile body M at the position is directed. In addition, the initial posture is information on the position and direction when the mobile body M that actually exists actually exists, and the surrounding posture is a posture corresponding to the initial posture, and is a virtual posture in a state in which at least one of the position or direction of the mobile body M is slightly different from the initial posture by a predetermined value.

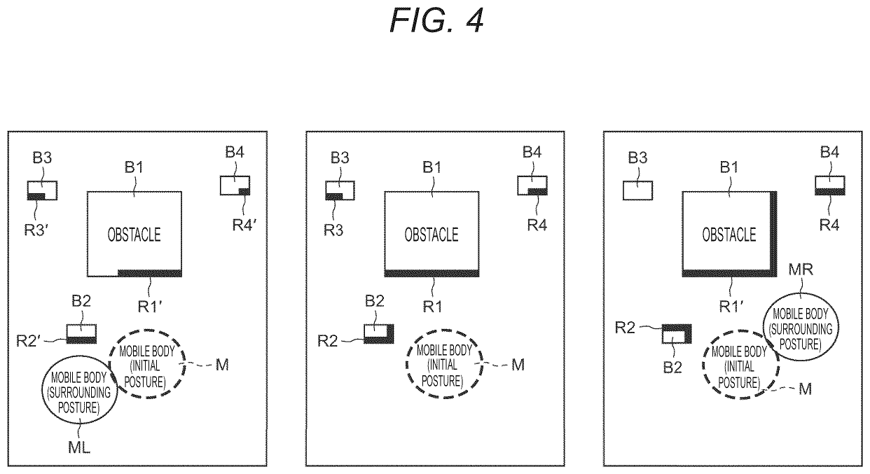

That is, in the present disclosure, on the basis of the mobile body M in the initial posture illustrated in the central part of FIG. 4 and the observation 3D terrains R1 to R4, for example, a model that infers (estimates) the observation 3D terrains R1′ to R4′, and R1″, R2″, and R4″ in the surrounding posture in which at least one of the position or the direction is slightly different by a predetermined value with respect to the initial posture as illustrated by the mobile bodies ML and MR in the left and right parts of FIG. 4 is introduced.

Note that, in FIG. 4, in order to simplify the notation, only the position of the mobile body M (it similarly applies to ML and MR) is illustrated, and the notation assumes that the sensing direction is in the entire range of 360 degrees.

In the left part of FIG. 4, the mobile body ML as a surrounding posture with respect to the mobile body M in an initial posture is assumed, and the observation 3D terrains R1′ to R4′ are inferred as sensor data that can be acquired in the surrounding posture to be the mobile body ML.

Since the mobile body ML is located below the obstacle B2 in the drawing as compared with the mobile body M, a field of view in an upper range in the drawing is blocked by the obstacle B2 than the mobile body M.

For this reason, the observation 3D terrains R1′ to R4′ observed in the mobile body ML in the surrounding posture have smaller areas of the observation regions than the observation 3D terrains R1 to R4 by the amount of the visibility blocked by the obstacle B2, and are considered to be inferior data for inferring the inference obstacles G1 to G4.

On the other hand, in the right part of FIG. 4, the mobile body MR is assumed as a surrounding posture with respect to the mobile body M, and the observation 3D terrains R1″, R2″, and R4″ are inferred as sensor data that can be acquired in the surrounding posture to be the mobile body MR.

Compared with the mobile body M, the mobile body MR is in a state in which there is no obstacle corresponding to the observation 3D terrain R3 since the obstacle B3 is an occlusion region of the obstacle B1.

Since the mobile body MR is located at a position where the right side surface of the obstacle B1 in the drawing is also visible as compared with the mobile body M, the mobile body MR is more excellent in observing the obstacles B1, B2, and B4 than the mobile body M. Therefore, the observation 3D terrains R1″, R2″, and R4″ have a larger area of the observation region than the observation 3D terrains R1, R2, and R4, and are considered to be excellent data for inference of the inference obstacles G1, G2, and G4, but are not suitable for inference of the inference obstacle G3.

However, the mobile body MR can infer the inference obstacles G1, G2, and G4 with higher accuracy than the mobile body M in the initial posture.

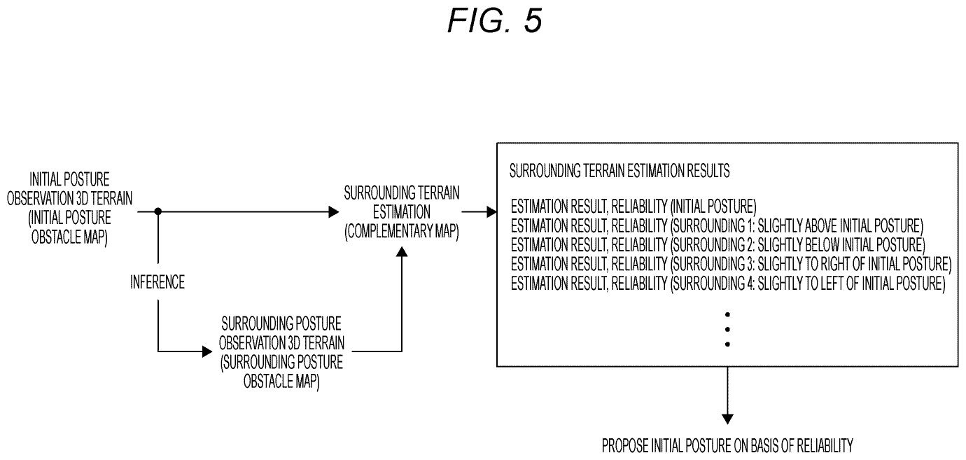

That is, in the present disclosure, as illustrated in FIG. 5, the initial posture, the estimation result of the surrounding terrain in each of the plurality of surrounding postures around the initial posture, and the reliability are obtained on the basis of the initial posture observation 3D terrain.

More specifically, by introducing a model including a neural network generated by machine learning, an observation 3D terrain acquired when the mobile body M moves to a plurality of surrounding postures around the initial posture is estimated on the basis of the initial posture observation 3D terrain.

First, a first estimation model in which sensor data when the mobile body M is assumed to move to a surrounding posture is estimated from sensor data in an initial posture of the mobile body M is introduced.

That is, as illustrated in FIG. 4, for example, a model in which the observation 3D terrains R1′ to R4′ and the observation 3D terrains R1″, R2″, and R4″ in the surrounding postures assumed to have moved to the mobile bodies ML and MR are estimated from the observation 3D terrains R1 to R4 which are sensor data in the initial posture of the mobile body M is introduced.

Note that the observation 3D terrain that is the sensor data in the initial posture of the mobile body M is also referred to as an initial posture obstacle map, and the observation 3D terrain that is the sensor data in the surrounding posture assumed to have moved to the mobile bodies ML and MR is also referred to as a surrounding posture obstacle map.

In addition, a second model is introduced in which each surrounding terrain is estimated on the basis of the observation 3D terrain acquired in each of the initial posture and the plurality of surrounding postures, and reliability is calculated for each of the estimation results. Note that the observation 3D terrain, which is the sensor data in the initial posture and the surrounding posture, includes many missing portions with respect to the actual surrounding terrain, and the surrounding terrain is estimated by complementing the missing portions. Therefore, the surrounding terrain as the estimation result is also referred to as a complementary map.

That is, as illustrated in FIG. 5, for example, the respective surrounding terrains (complementary maps) based on the sensor data of the initial posture and the surrounding posture are estimated from the observation 3D terrains R1 to R4 (initial posture obstacle maps) which are the sensor data in the initial posture of the mobile body M and the observation 3D terrains R1′ to R4′ or the observation 3D terrains R1″, R2″, and R4′ (surrounding posture obstacle maps) which are the sensor data in the surrounding posture assumed to have moved to the mobile bodies ML and MR.

In FIG. 5, as the surrounding terrain estimation result, “estimation result, reliability (initial posture)”, “estimation result, reliability (surrounding 1: slightly above initial posture)”, “estimation result, reliability (surrounding 2: slightly below initial posture)”, “estimation result, reliability (surrounding 3: slightly to the right of initial posture)”, and “estimation result, reliability (surrounding 4: slightly to the left of initial posture)” are written from the top.

That is, in FIG. 5, the estimation result and the reliability of the surrounding terrain are presented from the top for the initial posture of the mobile body M and each of the surrounding postures slightly above the initial posture, slightly below the initial posture, slightly to the right of the initial posture, and slightly to the left of the initial posture.

The estimation result is, for example, the inference obstacles G1 to G4 and the like in FIG. 3, and the reliability is the reliability of the entire estimation result as described with reference to FIG. 4.

As described above, in the present disclosure, the estimation result of the surrounding terrain and the reliability are obtained and presented so as to be able to be compared, whereby one of the initial posture and the estimation results of the plurality of surrounding postures can be selected according to the reliability.

Therefore, if the reliability of the estimation result in the initial posture is high, the route plan and the posture plan based on the estimation result are executed, and if the estimation result in the surrounding posture and the reliability are high, the mobile body moves so as to actually take the surrounding posture, the place is regarded as the initial posture, and the processing of obtaining the estimation result including the surrounding posture and the reliability is repeated again.

As a result, it is possible to move while repeating the route plan and the posture plan while selecting the position and the posture at which the surrounding terrain with high reliability can be acquired on the basis of the surrounding terrain and the reliability estimated by each of the initial posture and the surrounding posture.

As a result, even in an unknown space, it is possible to efficiently acquire an environment model related to a surrounding operating environment including three-dimensional spatial information.

### 2. Preferred Embodiments

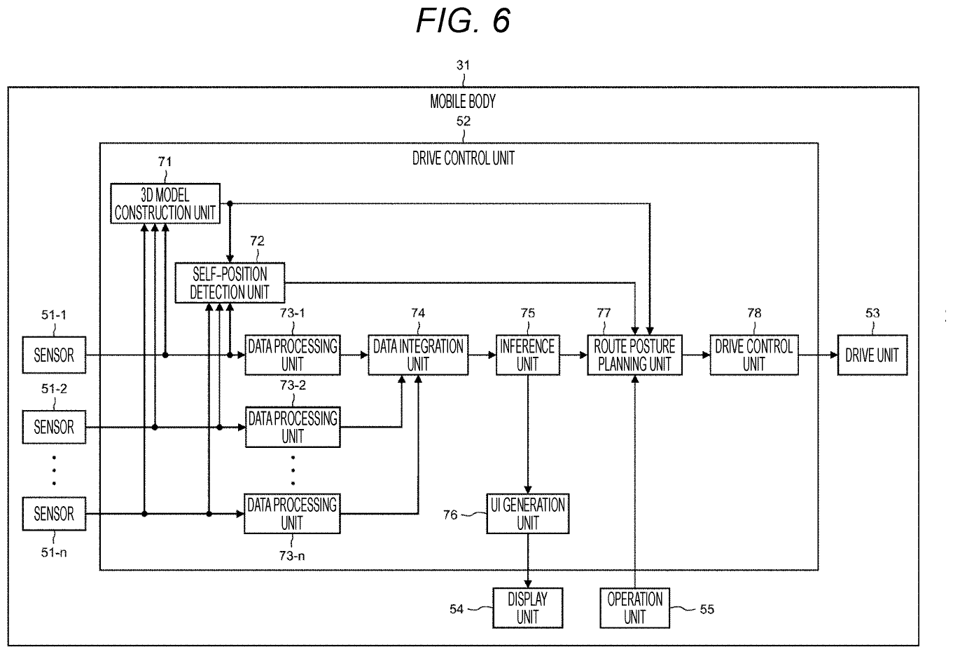

Next, a configuration example of the mobile body of the present disclosure will be described with reference to FIG. 6.

A mobile body 31 in FIG. 6 is a robot or the like having a function of moving on the basis of an instruction from a user and a function of autonomously moving, and any driving method may be used as long as the mobile body can move, such as a method of rotating and moving a drive wheel, a method of walking using a plurality of legs, and a method of rotating a main body.

More specifically, the mobile body 31 includes sensors 51-1 to 51-n, a drive control unit 52, a drive unit 53, a display unit 54, and an operation unit 55.

Note that, in a case where it is not necessary to particularly distinguish each of the sensors 51-1 to 51-n, it is simply referred to as a sensor 51, and the other configurations will be similarly referred to.

The sensors 51-1 to 51-n are various sensors used for acquiring a situation outside the mobile body 31, particularly surrounding three-dimensional spatial information, and supply sensor data from each sensor to the drive control unit 52. The type and number of the sensors 51-1 to 51-n are arbitrary.

For example, the sensors 51-1 to 51-n include a camera, a radar, a LIDAR (Light Detection and Ranging, Laser Imaging Detection and Ranging), and an ultrasonic sensor. The present invention is not limited thereto, and the sensors 51-1 to 51-n may include one or more types of sensors among a camera, a radar, a LIDAR, and an ultrasonic sensor. The number of cameras, radars, LiDARs, and ultrasonic sensors as the sensors 51-1 to 51-n is not particularly limited as long as the number of cameras, radars, LiDARs, and ultrasonic sensors can be practically installed in the mobile body 31. Furthermore, the types of the sensors 51-1 to 51-n are not limited to this example, and other types of sensors may be included.

Note that an imaging method of the camera as the sensor 51 is not particularly limited. For example, cameras of various imaging methods such as a time of flight (ToF) camera, a stereo camera, a monocular camera, and an infrared camera, which are imaging methods capable of distance measurement, can be applied to the camera as necessary. The present invention is not limited thereto, and the camera may simply acquire a captured image regardless of distance measurement.

The drive control unit 52 controls the entire movement of the mobile body 31 by controlling the drive of the drive unit 53 on the basis of the sensor data supplied from the sensor 51.

More specifically, the drive control unit 52 controls movement for acquiring an environment model including a surrounding operating environment including three-dimensional spatial information on the basis of sensor data supplied from the sensor 51. Here, the environment model including the surrounding operating environment including the three-dimensional spatial information is, for example, a local map including a 3D model around the mobile body 31.

The drive control unit 52 generates a local map on the basis of sensor data obtained by comprehensively sensing the periphery by the sensor 51 of the mobile body 31, and estimates the self-position while matching the generated local map with the global map.

Then, the drive control unit 52 executes a route plan and a posture plan of the mobile body 31 for moving from the estimated self-position to the destination and searching for the surroundings of the self-position, and controls the mobile body 31 along the route plan and the posture plan.

In an unknown space, what kind of obstacle exists in the periphery and what kind of route exists are unknown. Therefore, it is necessary for the drive control unit 52 to efficiently create the local map by planning the route and the posture of the mobile body 31 so that the sensor 51 can be comprehensively used.

Therefore, the drive control unit 52 plans a route for efficiently generating the local map on the basis of the sensor data supplied from the sensor 51, and creates the local map while moving along the planned route.

More specifically, as described above with reference to FIGS. 4 and 5, the drive control unit 52 estimates the surrounding terrain on the basis of the initial posture observation 3D terrain including the sensor data acquired by the sensor 51 in the initial posture that is the current posture.

Furthermore, the drive control unit 52 estimates a plurality of surrounding posture observation 3D terrains including sensor data acquired in a surrounding posture which is a plurality of positions and postures slightly different from the initial posture on the basis of the sensor data acquired by the sensor 51 in the initial posture which is the current posture, and then estimates a plurality of surrounding terrains on the basis of each of the plurality of estimated surrounding posture observation 3D terrains.

At this time, the drive control unit 52 also calculates the reliability of each of the initial posture observation 3D terrain and the surrounding terrain estimated on the basis of the plurality of surrounding posture observations 3D terrain including the sensor data.

Then, the drive control unit 52 presents the plurality of pieces of information of the surrounding terrain and the reliability obtained in this manner to the user as the UI image to prompt the user to select which one of the surrounding postures is to be taken, moves the mobile body 31 to take the selected surrounding posture, then detects the 3D model and the self-position on the basis of the sensor data after the movement to generate the local map, and repeats similar processing.

Alternatively, the drive control unit 52 presents the plurality of pieces of information of the surrounding terrain and the reliability obtained in this manner to the user as the UI image, moves the mobile body 31 to take a surrounding posture for estimating the surrounding terrain with the highest reliability, detects the 3D model and the self-position on the basis of sensor data detected by the sensor 51 to generate the local map, and repeats similar processing.

More specifically, the drive control unit 52 includes a 3D model construction unit 71, a self-position detection unit 72, data processing units 73-1 to 73-n, a data integration unit 74, an inference unit 75, a UI generation unit 76, a route posture planning unit 77, and a drive control unit 78.

The 3D model construction unit 71 constructs a 3D model on the basis of the sensor data of the sensors 51-1 to 51-n, generates a local map substantially including the 3D model, and outputs the local map to the self-position detection unit 72 and the route posture planning unit 77.

More specifically, the 3D model construction unit 71 generates a local map including, for example, a three-dimensional high-precision map created using a technology such as simultaneous localization and mapping (SLAM), an occupancy grid map, and the like.

The three-dimensional high-precision map is, for example, a point cloud map or the like. The occupancy grid map is a map that divides a three-dimensional or two-dimensional space around the mobile body 31 into grids of a predetermined size and indicates an occupancy state of an object in units of grids. The occupancy state of an object is indicated by, for example, the presence or absence or existence probability of the object.

The self-position detection unit 72 detects the self-position and the self-posture on the basis of the sensor data of the sensors 51-1 to 51-n and the local map including the 3D model, and outputs information of the detected self-position and self-posture to the route posture planning unit 77.

The data processing units 73-1 to 73-n process the sensor data supplied from the sensors 51-1 to 51-n into, for example, point cloud information of the same scale for integration, and output the processed information to the data integration unit 74.

The data integration unit 74 integrates sensor data processed for integration supplied from the data processing units 73-1 to 73-n, for example, point cloud information processed on the same scale into one piece of point cloud information, and outputs the integrated information to the inference unit 75.

The inference unit 75 generates the initial posture observation 3D terrain as sensor data when the current self-posture is set as the initial posture on the basis of the sensor data in which the respective sensor data in the sensors 51-1 to 51-n are integrated, estimates the surrounding terrain from the initial posture observation 3D terrain, and calculates the reliability thereof.

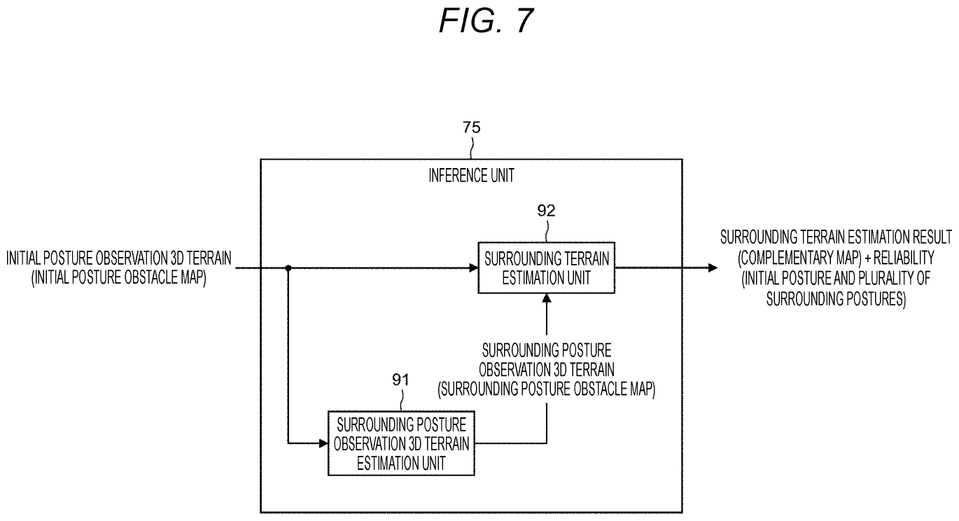

More specifically, as illustrated in FIG. 7, the inference unit 75 includes a surrounding posture observation 3D terrain estimation unit 91 and a surrounding terrain estimation unit 92.

The sensor data in which the respective sensor data in the sensors 51-1 to 51-n supplied to the inference unit 75 are integrated is, for example, 3D point cloud information, and can be said to be information of the observation 3D terrain observed in the initial posture if the current posture of the mobile body 31 is set as the initial posture.

Therefore, hereinafter, the inference unit 75 also refers to the sensor data in which the respective sensor data in the sensors 51-1 to 51-n are integrated as the initial posture observation 3D terrain.

The surrounding posture observation 3D terrain estimation unit 91 is an estimation model including a neural network or the like constructed by machine learning, and estimates the observation 3D terrain acquired in a plurality of surrounding postures slightly different in position and posture from the initial posture, that is, the surrounding posture observation 3D terrain on the basis of the initial posture observation 3D terrain, and outputs it to the surrounding terrain estimation unit 92.

For example, the surrounding posture observation 3D terrain estimation unit 91 is constructed by performing machine learning in a pair of an observation 3D terrain observed in a posture corresponding to an initial posture specified by various positions and directions with respect to the same three-dimensional spatial information and an observation 3D terrain observed in a posture corresponding to a surrounding posture slightly different in position and direction with respect to each posture.

The surrounding terrain estimation unit 92 is an estimation model including a neural network or the like constructed by machine learning, estimates each surrounding terrain on the basis of the initial posture observation 3D terrain and the plurality of surrounding posture observation 3D terrain corresponding to the initial posture, calculates the reliability of each surrounding terrain together with the estimation result, and outputs the reliability to the UI generation unit 76 and the route posture planning unit 77.

The surrounding terrain estimation unit 92 is constructed, for example, by performing machine learning in which an observation 3D terrain corresponding to sensor data and an actual surrounding terrain are paired.

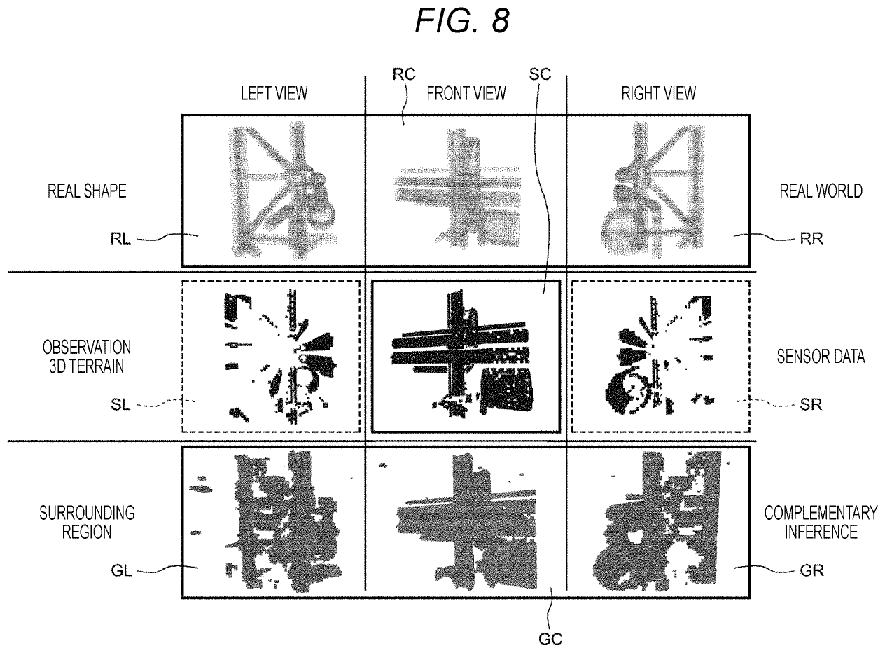

Note that specific processing examples by the surrounding posture observation 3D terrain estimation unit 91 and the surrounding terrain estimation unit 92 will be described later in detail with reference to FIG. 8.

The UI generation unit 76 (FIG. 6) generates a user interface (UI) image on the basis of the initial posture observation 3D terrain, the surrounding terrain estimated on the basis of each of the plurality of surrounding posture observation 3D terrains, and the information of the reliability of each of the estimated surrounding terrains, and displays the UI image on the display unit 54 including a display or the like to present the UI image to the user.

At this time, the corresponding initial posture and the plurality of surrounding postures are presented on the UI image on the basis of the estimated surrounding terrains and the information of each reliability, and information prompting Selection of any one of the initial posture and the plurality of surrounding postures is presented.

In this case, the operation unit 55 including an operation button, an operation key, a touch panel, and the like is operated, and information on the selected initial posture or surrounding posture is supplied to the route posture planning unit 77 on the basis of an operation signal corresponding to the operation content.

The route posture planning unit 77 plans a route and a posture on the basis of the local map supplied from the 3D model construction unit 71, the self-position supplied from the self-position detection unit 72, the initial posture supplied from the inference unit 75, the surrounding terrain estimation result for each of the plurality of surrounding postures, the information on the reliability, and the user's selection result based on the operation signal from the operation unit 55, and outputs the route and the posture to the drive control unit 78.

Note that, in the UI image, only the corresponding initial posture and the plurality of surrounding postures may be presented on the basis of the estimated surrounding terrains and the information of each reliability.

In this case, since there is no selection by the user, the route posture planning unit 77 adopts the initial posture in a case where the reliability of the surrounding terrain estimated on the basis of the initial posture is higher than a predetermined value on the basis of the information of the initial posture and the surrounding terrain estimation results and the reliability for each of the plurality of surrounding postures supplied from the inference unit 75, and selects the surrounding terrain estimation result with the highest reliability and plans the route and the posture in a case where the reliability of the surrounding terrain estimated on the basis of the initial posture is lower than the predetermined value.

Furthermore, in a case where there are a large number of initial postures and a plurality of surrounding postures, an initial posture and a plurality of surrounding postures with high reliability may be presented, or a UI image prompting the user to select one of the initial postures and the plurality of surrounding postures with high reliability may be displayed.

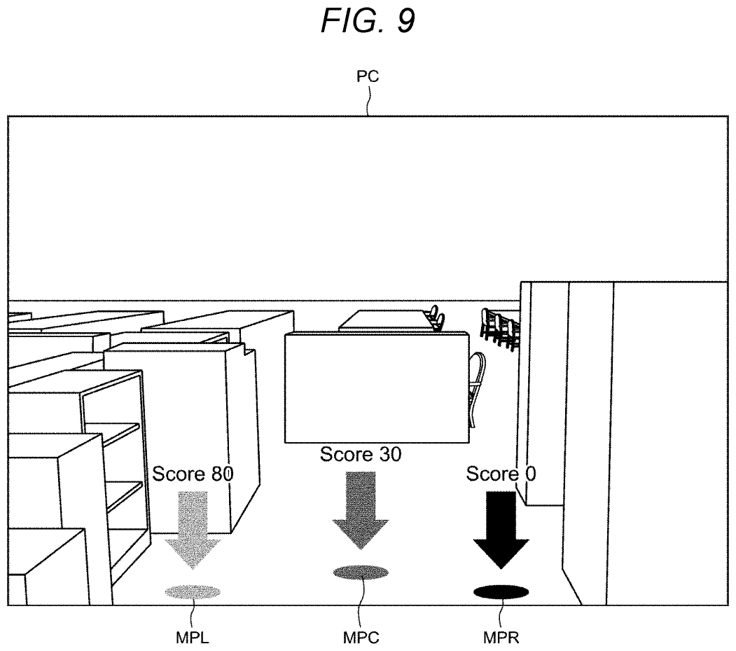

Note that a specific example of the UI image will be described later in detail with reference to FIGS. 9 to 13.

The drive control unit 78 drives the drive unit 53 so that the mobile body 31 moves on the basis of the information of the route and the posture planned by the route posture planning unit 77.

### Specific Processing Example by Surrounding Posture Observation Unit 3D Terrain Estimation Unit and Surrounding Terrain Estimation Unit

Next, specific processing examples by the surrounding posture observation unit 3D terrain estimation unit and the surrounding terrain estimation unit will be described with reference to FIG. 8.

A case where the real shape of the obstacle in the real world is, for example, as illustrated in the uppermost part of FIG. 8 will be considered.

In the uppermost part of FIG. 8, the real shape when the same obstacle existing in the real world is viewed from different viewpoints is expressed, and the real shape RL, the real shape RC, and the real shape RR are illustrated from the left in the drawing.

The real shape RC is a shape in the real world of the obstacle expressed in a front view observed from the current posture of the mobile body 31, that is, the initial posture.

The real shape RL is a shape in the real world of the obstacle expressed in a left view observed from the current posture of the mobile body 31, that is, a surrounding posture shifted to the left with respect to the obstacle as viewed from the initial posture.

The real shape RR is a shape in the real world of the obstacle expressed in the right view observed from the current posture of the mobile body 31, that is, a surrounding posture shifted to the right with respect to the obstacle as viewed from the initial posture.

Note that the real shapes RL, RC, and RR of the obstacles in FIG. 8 are all expressed in wire frame.

Here, the initial posture observation 3D terrain based on the sensor data obtained from the sensor 51 of the mobile body 31 in the initial posture is, for example, an observation 3D terrain SC in the middle of FIG. 8.

Note that the observation 3D terrain acquired in the initial posture is only the observation 3D terrain SC in the middle of FIG. 8.

Therefore, the surrounding posture observation 3D terrain estimation unit 91 estimates the surrounding posture observation 3D terrains SL and SR as illustrated in the middle left part and the right part of FIG. 8 on the basis of the observation 3D terrain SC which is the initial posture observation 3D terrain.

In this case, the surrounding posture observation 3D terrains SL and SR in the middle left part and the right part of FIG. 8 are information estimated from the observation 3D terrain SC which is the initial posture observation 3D terrain, and thus, there are many missing parts as the information of the observation 3D terrain.

The surrounding terrain estimation unit 92 estimates surrounding terrains GL, GC, and GR as illustrated in the lower part of FIG. 8 on the basis of each of the observation 3D terrains SL, SC, and SR.

That is, since all of the observation 3D terrains SC, SL, and SR are substantially sensor data of the sensor 51, a lack occurs in a detailed shape, and thus the surrounding terrain estimation unit 92 estimates the surrounding terrains GL, GC, and GR by complementing and inferring these.

At this time, in estimating the surrounding terrains GL, GC, and GR, the surrounding terrain estimation unit 92 also calculates the reliability depending on whether or not it is suitable for planning a route and a posture, such as the degree of complementation from the observation 3D terrains SL, SC, and SR, which are used sensor data, and the size of an occlusion region in each of the estimated surrounding terrains GL, GC, and GR.

For example, in a case where obstacles like a wall are present on one surface in a relatively wide range and at a relatively close position in the surrounding terrains GL, GC, and GR, and it is clear from the observation 3D terrain that these obstacles exist with a relatively high accuracy, the occlusion region is wide and it is not suitable for planning a route and a posture, and thus the reliability is set low.

On the other hand, in a case where the surrounding terrains GL, GC, and GR allow, for example, a large number of obstacles to be viewed and the unevenness thereof is clearly visible, it is suitable for planning a route and a posture, and thus the reliability is set high.

### Example of UI Image (Part 1)

Next, an example of a UI image generated by the UI generation unit 76 will be described with reference to FIGS. 9 to 11.

As described above, the UI generation unit 76 presents the UI image PC as illustrated in FIG. 9, for example, on the basis of the surrounding terrain and the reliability estimated by the initial posture and each of the plurality of surrounding postures by the surrounding terrain estimation unit 92 of the inference unit 75.

The UI image PC in FIG. 9 is an example of a UI image generated in an office in which bookshelves, desks, and chairs are arranged in the periphery.

In the UI image PC of FIG. 9, a position/posture mark MPC as an initial posture which is a current posture, a position/posture mark MPL as a surrounding posture shifted to the left side from the initial posture, and a position/posture mark MPR as a surrounding posture shifted to the right side from the initial posture are displayed as selectable initial posture and surrounding postures, respectively.

Further, as the respective reliabilities, scores indicating the reliabilities on the arrows corresponding to the position/posture marks MPL, MPC, and MPR are respectively written as “Score 80”, “Score 30”, and “Score 0”, and the arrows and the marks are respectively expressed in colors corresponding to the scores. Here, as the score indicating the reliability is higher, the color is expressed by a color closer to white, and as the score is lower, the color is expressed by a color closer to black.

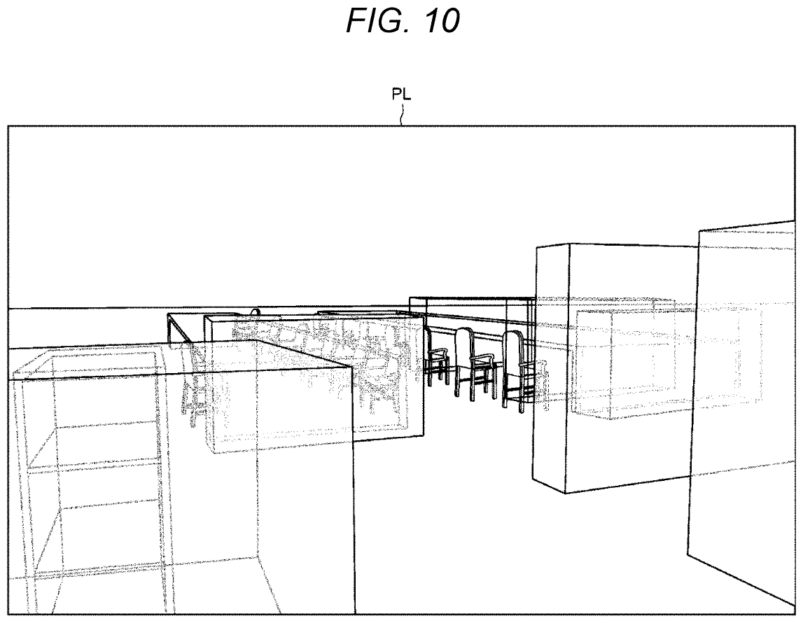

Furthermore, for example, when the pointer is moved to the position/posture mark MPL, the UI generation unit 76 reads the surrounding terrain estimated when the mobile body 31 is moved to the corresponding surrounding posture, and displays the surrounding terrain as the UI image PL as illustrated in FIG. 10, for example.

The UI image PL of FIG. 10 is a surrounding terrain that is expected to be obtained from the observation 3D terrain acquired when the mobile body 31 is moved to the surrounding posture corresponding to the position/posture mark MPL.

That is, the UI image PL in FIG. 10 corresponds to a scene seen when going around the right shelf in FIG. 9 to the left, and a route existing ahead of the right shelf can be confirmed with respect to the UI image PC in FIG. 9 obtained in the initial posture. Therefore, the reliability is set to “Score 80”, and is set higher than the reliability in the initial posture “Score 30”.

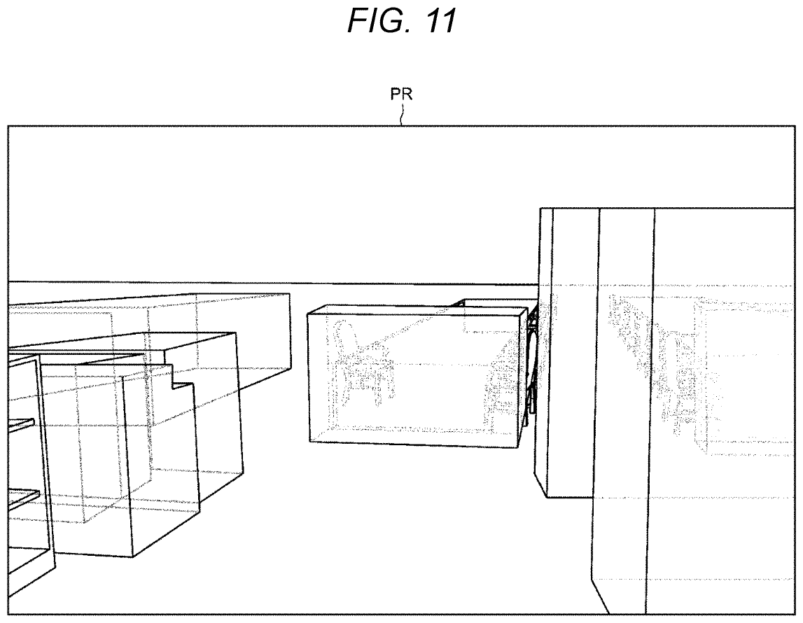

On the other hand, for example, when the pointer is moved to the position/posture mark MPR, the UI generation unit 76 reads the surrounding terrain estimated when the mobile body 31 is moved to the corresponding surrounding posture, and displays the surrounding terrain as the UI image PR as illustrated in FIG. 11, for example.

The UI image PR of FIG. 11 is a surrounding terrain that is expected to be obtained from the observation 3D terrain acquired when the mobile body 31 is moved to the surrounding posture corresponding to the position/posture mark MPR.

That is, the UI image PR in FIG. 11 corresponds to a scene seen when further going around the right shelf in FIG. 9 to the right, and a region hidden by the shelf increases with respect to the UI image PC in FIG. 9 obtained in the initial posture. Therefore, the reliability is set to “Score 0”, and is set lower than the reliability “Score 30” in the initial posture.

In this manner, as illustrated in FIG. 9, the user can visually recognize the initial posture and each of the plurality of surrounding postures as the position/posture marks MPL, MPC, and MPR, and further, can visually recognize the reliability of each posture with the UI image PC.

Furthermore, by moving the pointer to the position of each of the position/posture marks MPL, MPC, and MPR, it is possible to select one of the position/posture marks MPL, MPC, and MPR after visually confirming the surrounding terrain estimated to be actually acquired.

As a result, even if the mobile body 31 exists in an unknown space, it is possible to designate and move a position and a posture that are efficient for creating the local map.

### Example of UI Image (Part 2)

In the above description, an example of the UI image in a case where the position/posture mark is displayed in a relatively wide space has been described. However, for example, in a narrow space, it is difficult to see the score when the score is written in text, and thus the score may be displayed only in color.

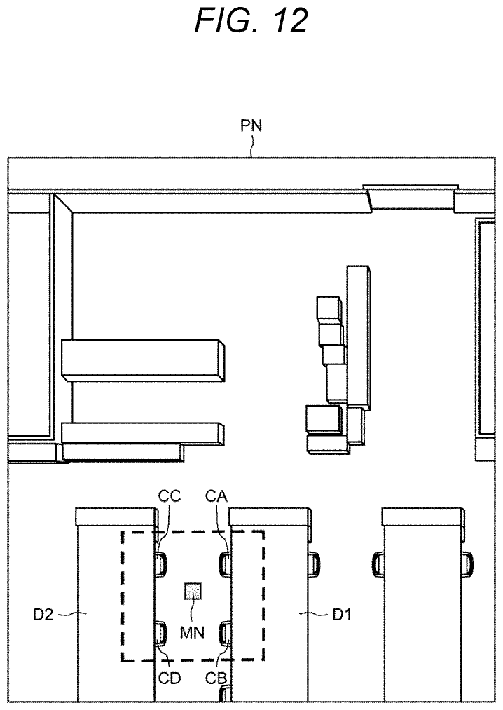

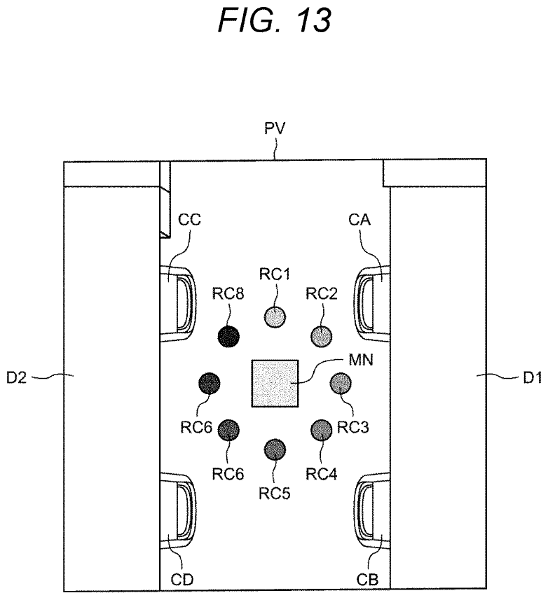

For example, in a case where an office is displayed by a UI image PN as illustrated in FIG. 12, and in a case where a position/posture mark MN corresponding to the initial posture of the mobile body 31 is present in a space sandwiched between desks D1 and D2 and further surrounded by chairs CA, CB, CC, and CD indicated in a dotted frame, the UI generation unit 76 generates a UI image as illustrated in FIG. 13, for example.

FIG. 13 is an enlarged view PV of a region surrounded by a dotted line in the UI image PN of FIG. 12.

That is, in a case where there are eight surrounding postures around the position/posture mark MN corresponding to the initial posture, the UI generation unit 76 displays only the position/posture marks RC1 to RC8 at the positions where the surrounding postures exist, and displays the position/posture marks RC1 to RC8 in colors corresponding to the reliability.

In this way, the user can recognize the current position and posture corresponding to the initial posture by the position/posture mark MN, further, the surrounding postures can be recognized by the position/posture marks RC1 to RC8, and further, each score can be recognized by color.

Furthermore, when the pointer is moved to each position, the surrounding terrain estimated to be acquired in a case where the mobile body 31 takes the surrounding postures corresponding to the position/posture marks RC1 to RC8 as described with reference to FIGS. 10 and 11 may be displayed.

### Drive Control Process

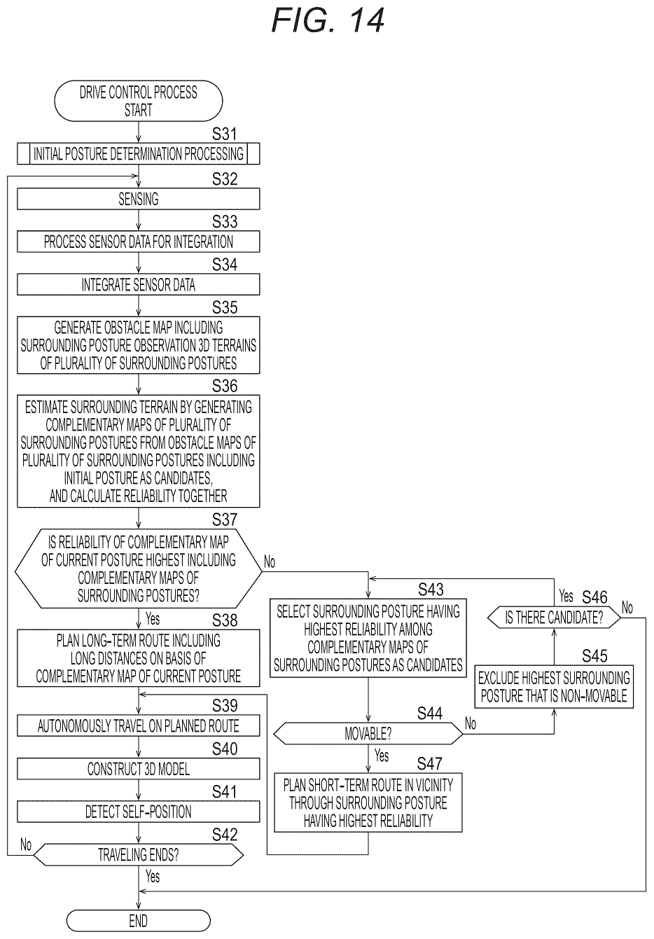

Next, a drive control process by the mobile body 31 in FIG. 6 will be described with reference to a flowchart in FIG. 14.

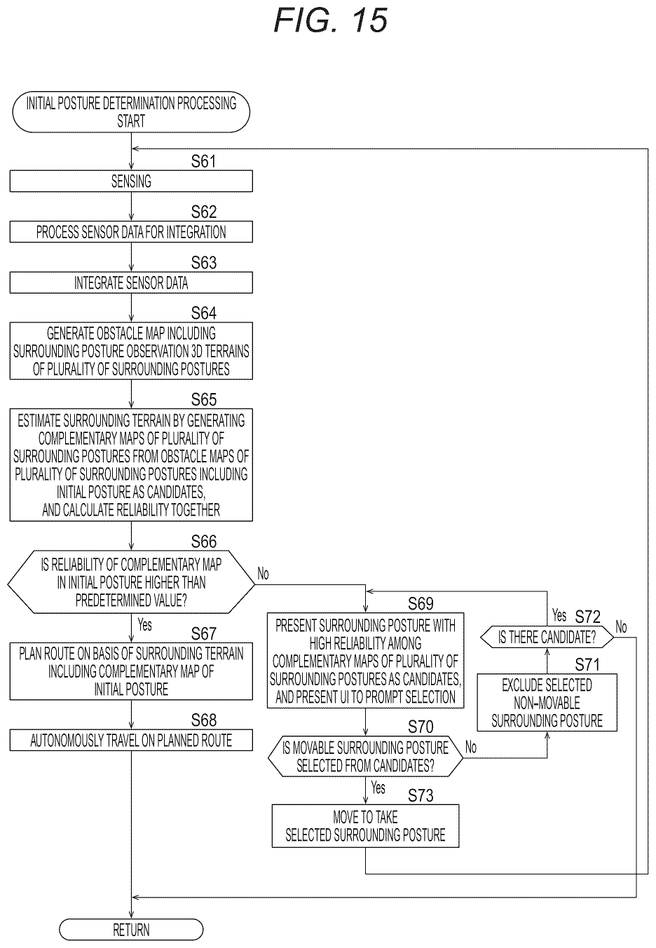

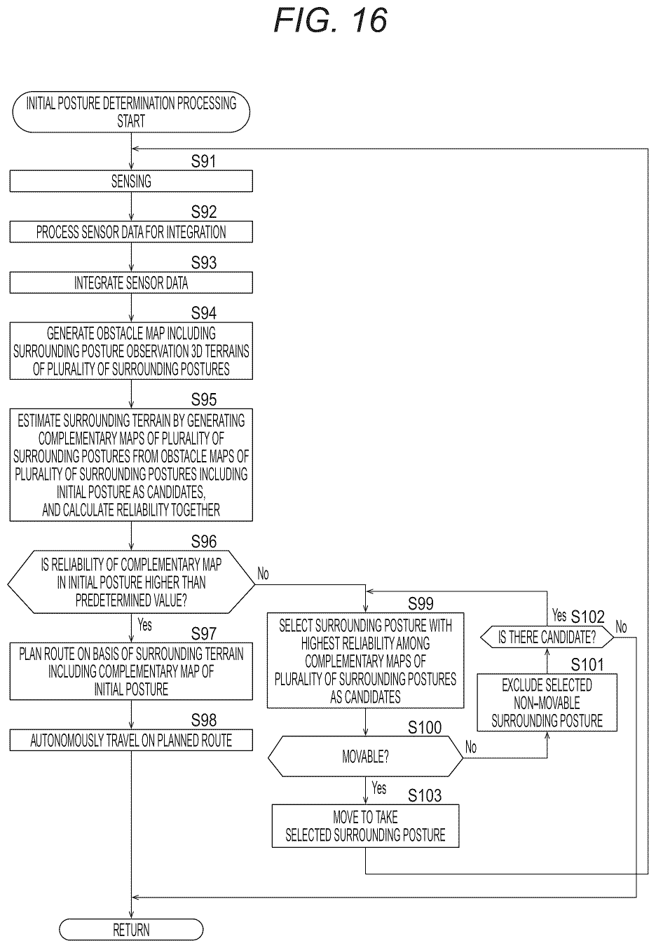

In step S31, the initial posture determination processing is executed, the initial posture is determined, and autonomous traveling is started. Note that the initial posture determination processing will be described later in detail with reference to FIGS. 15 and 16.

In step S32, the sensors 51-1 to 51-n respectively sense information required for recognizing the situation outside the mobile body 31, in particular, the surrounding space, and output sensor data as sensing results to the 3D model construction unit 71, the self-position detection unit 72, and the data processing units 73-1 to 73-n, respectively.

In step S33, the data processing units 73-1 to 73-n process the sensor data of the sensors 51-1 to 51-n into a format such as 3D point cloud information of the same scale that can be integrated in the data integration unit 74, for example, and output the processed sensor data to the data integration unit 74.

In step S34, when acquiring the sensor data processed into the integratable format supplied from the data processing units 73-1 to 73-n, the data integration unit 74 integrates them to generate, for example, an initial posture observation 3D terrain including one piece of 3D point cloud information, and outputs the generated initial posture observation 3D terrain to the inference unit 75 as an obstacle map.

Note that the processing here is processing after the initial posture is determined by the initial posture determination processing in step S31 to be described later and the autonomous traveling is started. Therefore, strictly, the initial posture observation 3D terrain here is the observation 3D terrain at the current position and posture (hereinafter, also referred to as a current posture) during the autonomous traveling. However, hereinafter, the observation 3D terrain generated by integrating the sensor data of the sensors 51-1 to 51-n is also referred to as an initial posture observation 3D terrain.

In step S35, the surrounding posture observation 3D terrain estimation unit 91 in the inference unit 75 generates obstacle maps of a plurality of surrounding postures including the surrounding posture observation 3D terrains of a plurality of surrounding postures on the basis of the obstacle map including the initial posture observation 3D terrain, and outputs the obstacle maps to the surrounding terrain estimation unit 92.

In step S36, the surrounding terrain estimation unit 92 estimates the surrounding terrain by generating the complementary maps of the plurality of surrounding postures from the obstacle maps of the plurality of surrounding postures including the initial posture, calculates the reliability for each surrounding terrain estimation result, that is, for each of the complementary maps of the plurality of surrounding postures, and outputs the surrounding terrain estimation result and the information of the reliability to the UI generation unit 76 and the route posture planning unit 77 as candidates of the position and the posture.

In step S37, the route posture planning unit 77 determines whether or not the reliability of the complementary map of the current posture, that is, the initial posture is the highest.

In a case where it is determined in step S37 that the reliability of the complementary map of the current posture, that is, the initial posture is the highest, the process proceeds to step S38.

In step S38, the route posture planning unit 77 plans a long-term route on the basis of the information of the surrounding terrain corresponding to the complementary map of the current posture, that is, the initial posture, and the information of the local map and the self-position, and outputs plan information to the drive control unit 78.

That is, in a case where the reliability of the complementary map of the current posture is the highest, the reliability is higher than that of moving from the current posture to the surrounding posture and newly generating the complementary map. Therefore, a route (long-term route) longer than a predetermined distance starting from the current posture within a range that can be viewed from the complementary map of the current posture is planned.

In step S39, the drive control unit 78 drives the drive unit 53 on the basis of the long-term route plan information supplied from the route posture planning unit 77.

In step S40, the 3D model construction unit 71 constructs a 3D model around the mobile body 31 on the basis of the sensor data of the sensors 51-1 to 51-n, generates a local map, and outputs the local map to the self-position detection unit 72 and the route posture planning unit 77.

In step S41, the self-position detection unit 72 detects the self-position on the basis of the sensor data of the sensors 51-1 to 51-n and the local map supplied from the 3D model construction unit 71, and outputs information of the detected self-position to the route posture planning unit 77.

In step S42, the route posture planning unit 77 determines whether or not the operation unit 55 has been operated and an end instruction has been given.

In step S42, in a case where the end is not instructed, the process returns to step S32, and the subsequent processes is repeated.

In addition, in a case where the end is instructed in step S42, the process ends.

On the other hand, in a case where it is determined in step S37 that the reliability of the complementary map of the current posture, that is, the initial posture is not the highest, the process proceeds to step S43.

In step S43, the route posture planning unit 77 selects a surrounding posture having the highest reliability among the complementary maps of the plurality of surrounding postures as candidates.

In step S44, the route posture planning unit 77 determines whether or not the selected surrounding posture with the highest reliability is movable.

In step S44, in a case where the surrounding posture having the highest reliability among the complementary maps of the plurality of surrounding postures is not movable, the process proceeds to step S45.

In step S45, the route posture planning unit 77 excludes, from the candidates, the selected surrounding posture that has the highest reliability and is non-movable.

In step S46, the route posture planning unit 77 determines whether or not a candidate surrounding posture remains.

In step S46, in a case where a candidate surrounding posture remains, the process returns to step S43.

That is, the processing of steps S43 to S46 is repeated until a surrounding posture having the highest reliability and being movable is selected among the plurality of candidate surrounding postures.

Then, in a case where it is determined in step S44 that a surrounding posture having the highest reliability and being movable is selected among the plurality of candidate surrounding postures, the process proceeds to step S47.

In step S47, the route posture planning unit 77 plans a short-term route in a range in the vicinity closer than a predetermined distance from the current posture passing through the surrounding posture having the highest reliability, and outputs the plan information to the drive control unit 78, and the process proceeds to step S39.

That is, in a case where the degree of reliability of the complementary map of the current posture is not the highest and a complementary map of a surrounding posture that is another candidate is selected, the complementary map generated newly after temporarily moving from the current posture to the surrounding posture has higher degree of reliability.

For this reason, there is a possibility that a route with higher moving efficiency is planned in the newly planned route on the basis of the complementary map obtained by moving to the surrounding posture, and thus, a route (short-term route) shorter than the predetermined distance and having a relatively short distance is planned.

By the above processing, while the autonomous traveling is continued after the initial posture is determined, the complementary map of the initial posture corresponding to the current posture based on the sensor data and the complementary map of the surrounding posture of the current posture are generated.

Then, in a case where the reliability of the complementary map of the current posture is the highest, a long-term route longer than a predetermined distance is planned on the basis of the complementary map obtained from the current posture, and in a case where the reliability of the complementary map of the current posture is not the highest, a short-term route shorter than a predetermined distance passing through the surrounding posture with the highest reliability is planned on the basis of the complementary map of the surrounding posture with the highest reliability.

As a result, in a case where the reliability of the complementary map obtained in the current posture is the highest, the long-term route is planned, so that it is possible to reduce processing with a high processing load, such as generating the obstacle map on the basis of the sensor data and generating the complementary maps of the plurality of surrounding postures, and to implement efficient autonomous traveling.

In addition, in a case where the reliability of the complementary map obtained in the current posture is not the highest, a short-term route is planned so as to pass through the candidate surrounding posture with the highest reliability, whereby it is possible to implement efficient autonomous traveling while appropriately planning a highly reliable route by repeating processing of generating an obstacle map on the basis of sensor data and generating complementary maps of a plurality of surrounding postures.

As a result, in any case, even when a mobile body such as a self-propelled robot including a sensor moves in an unknown space, it is possible to efficiently acquire three-dimensional spatial information and to autonomously travel while appropriately planning a position and a posture on the basis of the acquired three-dimensional spatial information.

Note that, in the above example, an example has been described in which a 3D model is constructed by autonomous movement to generate a local map. However, the processing performed with the autonomous movement is not limited thereto, and for example, a specific object or person may be searched for.

### Initial Posture Determination Processing (Part 1)

Next, the initial posture determination processing in a case where the user intervenes in the operation will be described with reference to the flowchart of FIG. 15. Note that the processing in steps S61 to S65 in FIG. 15 is similar to the processing in steps S32 to S36 in FIG. 14, and thus the description thereof will be omitted.

That is, in step S61, sensor data is acquired by the sensors 51-1 to 51-n, processed for integration in step S62, integrated in step S63, an initial posture observation 3D terrain including 3D point cloud information is output to the inference unit 75 as an obstacle map in step S64, complementary maps and reliabilities of a plurality of surrounding postures are calculated from obstacle maps of a plurality of surrounding postures including an initial posture in step S65, and surrounding terrain estimation results and information of the reliabilities are output to the UI generation unit 76 and the route posture planning unit 77 as candidates of a position and a posture.

In step S66, the route posture planning unit 77 determines whether or not the reliability of the complementary map of the initial posture is higher than a predetermined value.

In a case where it is determined in step S66 that the reliability of the complementary map of the initial posture is higher than the predetermined value, the process proceeds to step S67.

In step S67, the route posture planning unit 77 plans a route and a posture on the basis of information on the surrounding terrain corresponding to the complementary map of the initial posture, and outputs plan information to the drive control unit 78.

In step S68, the drive control unit 78 drives the drive unit 53 on the basis of the route and posture plan information supplied from the route posture planning unit 77 to start autonomous traveling.

That is, in a case where the reliability of the complementary map of the current posture is higher than a predetermined value, a route and a posture are planned from the complementary map of the initial posture, and autonomous traveling is started.

In a case where it is determined in step S66 that the reliability of the complementary map of the initial posture is not higher than the predetermined value, the process proceeds to step S69.

In step S69, the UI generation unit 76 presents a surrounding posture with high reliability that is high among the complementary maps of the plurality of surrounding postures, and prompts the selection of one of the surrounding postures as a selection destination, for example, generates a UI image as described with reference to FIGS. 9 and 13, and displays the UI image on the display unit 54.

In step S70, the route posture planning unit 77 determines, on the basis of the UI image, whether or not the movable surrounding posture is selected as the moving destination by operating the operation unit 55 among the plurality of candidate surrounding postures.

In step S70, in a case where the non-movable surrounding posture is selected as the moving destination among the plurality of surrounding postures by operating the operation unit 55, the process proceeds to step S71.

In step S71, the non-movable surrounding posture is excluded from the complementary maps of the plurality of surrounding postures.

In step S72, the route posture planning unit 77 and the UI generation unit 76 determine whether or not a candidate surrounding posture remains, and in a case where a candidate surrounding posture remains, the process returns to step S69.

That is, until the movable surrounding posture is determined as the moving destination, the processing of presenting the one with the higher reliability among the plurality of candidate surrounding postures and displaying the UI image prompting the selection is repeated.

Then, in step S70, in a case where the movable surrounding posture is selected as the moving destination among the plurality of surrounding postures by operating the operation unit 55, the process proceeds to step S73.

In step S73, the route posture planning unit 77 plans a route and a posture for movement so as to take the selected surrounding posture, and outputs plan information to the drive control unit 78.

As a result, the drive control unit 78 controls the drive unit 53 to move the mobile body 31 so as to have the selected surrounding posture, the process returns to step S61, and the subsequent processes are repeated.

That is, until an initial posture in which the reliability of the complementary map in the initial posture is higher than a predetermined value is obtained, the processing of moving to the surrounding posture, performing sensing by the sensor 51, generating the obstacle map, and generating the complementary map is repeated.

Then, when an initial posture in which the reliability of the complementary map in the initial posture is higher than a predetermined value is obtained, a route is planned on the basis of the complementary map, and autonomous traveling is started.

Note that, in step S72, in a case where it is determined that the surrounding postures are not left, that is, in a case where all the selectable surrounding postures are not movable, the process ends.

At this time, since there is no movable surrounding posture, the UI generation unit 76 may generate a UI image indicating that the processing ends and display the UI image on the display unit 54.

By the above processing, in the initial posture, the initial posture observation 3D terrain is generated as the obstacle map on the basis of the sensor data of the sensors 51-1 to 51-n, and the obstacle maps of the plurality of surrounding postures including the plurality of surrounding posture observation 3D terrains are estimated from the generated obstacle map of the initial posture including the initial posture observation 3D terrain.

In addition, by complementing the missing part of each of the obstacle maps of the plurality of surrounding postures including the obstacle map of the initial posture, the surrounding terrain for each surrounding posture is estimated, the estimation result is output as the complementary map, and at that time, the reliability of the generated complementary map for each surrounding posture is also calculated.

Then, as long as the reliability of the complementary map of the initial posture is lower than a predetermined value, a UI image that presents the complementary map of the surrounding posture and the respective reliability to the user is generated and displayed, and when any of the surrounding postures is selected, processing of controlling and driving the mobile body 31 so as to take the selected surrounding posture is repeated.

Then, when the reliability of the complementary map of the initial posture becomes higher than a predetermined value, a route and a posture are planned on the basis of the complementary map of the initial posture, and autonomous traveling is started.

As a result, even in a completely unknown space, the mobile body can start autonomous traveling from an initial posture in which a complementary map with reliability higher than a predetermined value can be generated, and thus, it is possible to autonomously travel while efficiently acquiring three-dimensional spatial information.

### Initial Posture Determination Processing (Part 2)

In the above description, an example has been described in which, in a case where the reliability of the complementary map in the initial posture is lower than a predetermined value, the reliability of the complementary map of the surrounding posture is presented until the reliability of the complementary map in the initial posture is considered to be higher than the predetermined value, a UI image prompting selection of any one is generated, one of the surrounding postures is selected, and processing of changing the initial posture is repeated.

However, in a case where the reliability of the complementary map in the initial posture is lower than a predetermined value, the surrounding posture in which the reliability of the complementary map is the highest is selected, and the mobile body 31 may be autonomously controlled and driven so as to sequentially take the selected surrounding postures in which the reliability is the highest.

FIG. 16 is a flowchart for explaining initial posture determination processing in which, in a case where the reliability of the complementary map in the initial posture is lower than a predetermined value, the surrounding posture having the highest reliability of the complementary map is selected until the reliability of the complementary map in the initial posture is regarded as higher than the predetermined value, and the mobile body is autonomously moved so as to sequentially take the selected surrounding posture having the highest reliability.

Note that the processing in steps S91 to S98, S101, and S102 in FIG. 16 is similar to the processing in steps S61 to S68, S71, and S72 in FIG. 15, and thus description thereof is omitted.

That is, in a case where it is determined in step S96 that the reliability of the complementary map of the initial posture is not higher than the predetermined value, the process proceeds to step S99.

In step S99, the route posture planning unit 77 selects a surrounding posture with the highest reliability among the complementary maps of the plurality of surrounding postures.

In step S100, the route posture planning unit 77 determines whether or not the surrounding posture having the highest reliability among the complementary maps of the plurality of surrounding postures is movable.

In step S100, in a case where the surrounding posture having the highest reliability among the complementary maps of the plurality of surrounding postures is movable, the process proceeds to step S103.

In step S103, the route posture planning unit 77 plans a route and a posture so as to move to a surrounding posture with the highest reliability, and outputs plan information to the drive control unit 78.

As a result, the drive control unit 78 controls the drive unit 53 to move the mobile body 31 to the selected surrounding posture with the highest reliability, the process returns to step S91, and the subsequent processes are repeated.

In addition, in step S100, in a case where the surrounding posture having the highest reliability among the complementary maps of the plurality of surrounding postures is not movable, the process proceeds to step S101.

As a result of the above processing, as long as the reliability of the complementary map of the initial posture is lower than the predetermined value, the processing of controlling and driving the mobile body 31 so as to take the surrounding posture with the highest reliability in the complementary map of the surrounding posture is repeated.

Then, when the reliability of the complementary map of the initial posture becomes higher than a predetermined value, a route and a posture are planned on the basis of the complementary map of the initial posture, and autonomous traveling is started.

As a result, even in a completely unknown space, the mobile body can start autonomous traveling from an initial posture in which a complementary map with reliability higher than a predetermined value can be generated, and thus, it is possible to autonomously travel while efficiently acquiring three-dimensional spatial information.

### 3. Example Executed by Software

Meanwhile, the above-described series of processing can be executed by hardware, but can also be executed by software. In a case where the series of processing is executed by software, a program constituting the software is installed from a recording medium to a computer incorporated in dedicated hardware or, for example, a general-purpose computer or the like capable of executing various functions by installing various programs.

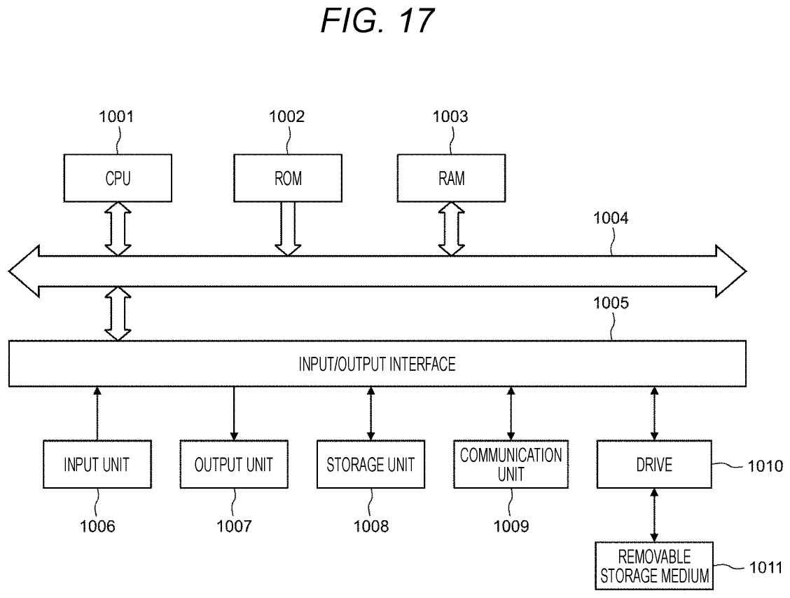

FIG. 17 illustrates a configuration example of a general-purpose computer. This computer incorporates a central processing unit (CPU) 1001. An input/output interface 1005 is connected to the CPU 1001 via a bus 1004. A read only memory (ROM) 1002 and a random access memory (RAM) 1003 are connected to the bus 1004.

The input/output interface 1005 is connected with an input unit 1006 including an input device such as a keyboard or a mouse with which a user inputs an operation command, an output unit 1007 that outputs a processing operation screen or an image of a processing result to a display device, a storage unit 1008 including a hard disk drive or the like that stores a program or various data, and a communication unit 1009 including a local area network (LAN) adapter or the like that executes communication processing via a network represented by the Internet. Furthermore, a drive 1010 that reads and writes data from and to a removable storage medium 1011 such as a magnetic disk (including a flexible disk), an optical disk (including a compact disc-read only memory (CD-ROM) and a digital versatile disc (DVD)), a magneto-optical disk (including a mini disc (MD) ), or a semiconductor memory is connected.

The CPU 1001 executes various processes according to a program stored in the ROM 1002 or a program read from the removable storage medium 1011 such as a magnetic disk, an optical disk, a magneto-optical disk, or a semiconductor memory, installed in the storage unit 1008, and loaded from the storage unit 1008 to the RAM 1003. The RAM 1003 also appropriately stores data and the like necessary for the CPU 1001 to execute various processes.

In the computer configured as described above, for example, the CPU 1001 loads a program stored in the storage unit 1008 into the RAM 1003 via the input/output interface 1005 and the bus 1004 and executes the program, whereby the above-described series of processing is performed.

The program executed by the computer (CPU 1001) can be provided by being recorded in the removable storage medium 1011 as a package medium or the like, for example. Furthermore, the program can be provided via a wired or wireless transmission medium such as a local area network, the Internet, or digital satellite broadcasting.

In the computer, the program can be installed in the storage unit 1008 via the input/output interface 1005 by attaching the removable storage medium 1011 to the drive 1010. Furthermore, the program can be received by the communication unit 1009 via a wired or wireless transmission medium and installed in the storage unit 1008. In addition, the program can be installed in the ROM 1002 or the storage unit 1008 in advance.

Note that the program executed by the computer may be a program in which processing is performed in time series in the order described in the present specification, or may be a program in which processing is performed in parallel or at necessary timing such as when a call is made.

Note that the CPU 1001 in FIG. 17 implements the function of the drive control unit 52 of the mobile body 31 in FIG. 6, the input unit 1006 in FIG. 17 implements the function of the operation unit 55 in FIG. 6, and the output unit 1007 in FIG. 17 implements the function of the display unit 54 in FIG. 6.

In addition, in the present specification, a system means a set of a plurality of components (apparatuses, modules (parts), or the like), and it does not matter whether or not all the components are in the same housing. Therefore, a plurality of apparatuses housed in separate housings and connected via a network and one apparatus in which a plurality of modules is housed in one housing are both systems.

Note that the embodiments of the present disclosure are not limited to the above-described embodiments, and various modifications can be made without departing from the gist of the present disclosure.

For example, the present disclosure can have a configuration of cloud computing in which one function is shared and processed in cooperation by a plurality of apparatuses via a network.

Furthermore, each step described in the above-described flowchart can be executed by one apparatus or can be shared and executed by a plurality of apparatuses.

Furthermore, in a case where a plurality of processes is included in one step, the plurality of processes included in the one step can be executed by one apparatus or can be shared and executed by a plurality of apparatuses.

Note that the present disclosure can also have the following configurations.

<1> An information processing apparatus including:
a surrounding posture observation three-dimensional terrain estimation unit that estimates a plurality of surrounding posture observation three-dimensional terrains around a mobile body detected by a sensor of the mobile body in a plurality of surrounding postures in which at least one of a position or a direction is different by a predetermined value from an initial posture on the basis of an initial posture observation three-dimensional terrain around the mobile body detected by the Sensor of the mobile body in the initial posture;
a surrounding terrain estimation unit that estimates a terrain around the mobile body as a surrounding terrain on the basis of the initial posture observation three-dimensional terrain and each of the plurality of surrounding posture observation three-dimensional terrains; and
a control unit that plans a route and a posture of the mobile body and controls movement on the basis of the surrounding terrain estimated by the surrounding terrain estimation unit.

<2> The information processing apparatus according to <1>, in which
the surrounding terrain estimation unit estimates the terrain around the mobile body as the surrounding terrain and calculates reliability of each surrounding terrain on the basis of the initial posture observation three-dimensional terrain and each of the plurality of surrounding posture observation three-dimensional terrains.

<3> The information processing apparatus according to <2>, in which
in a case where the reliability of an initial posture surrounding terrain estimated on the basis of the initial posture observation three-dimensional terrain among the surrounding terrains estimated by the surrounding terrain estimation unit is higher than a predetermined value, the control unit plans the route and the posture of the mobile body on the basis of the initial posture surrounding terrain and starts autonomous movement.

<4> The information processing apparatus according to <2>, in which
in a case where the reliability of an initial posture surrounding terrain estimated on the basis of the initial posture observation three-dimensional terrain among the surrounding terrains estimated by the surrounding terrain estimation unit is lower than a predetermined value, the control unit plans the route and the posture of the mobile body and controls movement on the basis of a surrounding posture surrounding terrain which is the surrounding terrain estimated on the basis of the plurality of surrounding posture observation three-dimensional terrains.

<5> The information processing apparatus according to <4>, further including
a user interface (UI) generation unit that presents, as a candidate, the surrounding posture in which the reliability of the surrounding posture surrounding terrain estimated is high, and generate a UI image prompting selection of any one of the candidates, in which
the control unit plans the route and the posture of the mobile body and controls movement to take a position and a posture corresponding to the surrounding posture as the candidate selected among the surrounding postures presented as the candidates in the UI image.

<6> The information processing apparatus according to <5>, in which
after the control unit plans the route and the posture of the mobile body and controls movement to take the position and the posture corresponding to the surrounding posture as the candidate selected among the surrounding postures presented as the candidates in the UI image,
the surrounding posture observation three-dimensional terrain estimation unit regards the surrounding posture as the candidate selected as a new initial posture, and estimates a plurality of new surrounding posture observation three-dimensional terrains on the basis of an initial posture observation three-dimensional terrain in the new initial posture,
the surrounding terrain estimation unit estimates the surrounding terrain from each of the initial posture observation three-dimensional terrain being new and the plurality of new surrounding posture observation three-dimensional terrains, and
the control unit repeats similar processing until it is determined that the reliability of the initial posture surrounding terrain estimated on the basis of the initial posture observation three-dimensional terrain among the surrounding terrains estimated by the surrounding terrain estimation unit is higher than a predetermined value.

<7> The information processing apparatus according to <5>, in which
the UI image presents, as the candidate, the surrounding posture in which the reliability of the surrounding posture surrounding terrain estimated is high together with information indicating the reliability.

<8> The information processing apparatus according to <7>, in which
the UI image presents, as the candidate, the surrounding posture in which the reliability of the surrounding posture surrounding terrain estimated is high together with information colored corresponding to the reliability.

<9> The information processing apparatus according to <5>, in which when a pointer is moved to a position where the surrounding posture is presented as the candidate in the UI image, the UI generation unit generates and displays the UI image based on the surrounding posture surrounding terrain estimated when the mobile body moves to the surrounding posture where the pointer is located.

<10> The information processing apparatus according to <5>, in which
in a case where it is not possible to move the mobile body to take the position and the posture corresponding to the surrounding posture as the candidate selected among the surrounding postures presented in the UI image, the control unit excludes information of the surrounding posture selected from the candidates.

<11> The information processing apparatus according to <2>, in which
in a case where the reliability of an initial posture surrounding terrain estimated on the basis of the initial posture observation three-dimensional terrain is lower than a predetermined value among the surrounding terrains estimated by the surrounding terrain estimation unit, the control unit plans the route and the posture of the mobile body and controls movement on the basis of the surrounding posture in which the reliability of a surrounding posture surrounding terrain that is the surrounding terrain estimated on the basis of the plurality of surrounding posture observation three-dimensional terrains is highest.

<12> The information processing apparatus according to <3>, in which
in a case where the reliability of the initial posture surrounding terrain estimated on the basis of the initial posture observation three-dimensional terrain among the surrounding terrains estimated by the surrounding terrain estimation unit is higher than a predetermined value after the route and the posture of the mobile body are planned on the basis of the initial posture surrounding terrain and the autonomous movement is started, the control unit plans a long-term route of the mobile body starting from the initial posture on the basis of the initial posture surrounding terrain, and controls the movement of the mobile body on the basis of the long-term route planned.

<13> The information processing apparatus according to <3>, in which
in a case where the reliability of the initial posture surrounding terrain estimated on the basis of the initial posture observation three-dimensional terrain among the surrounding terrains estimated by the surrounding terrain estimation unit is lower than a predetermined value after the route and the posture of the mobile body are planned on the basis of the initial posture surrounding terrain and the autonomous movement is started, the control unit plans a short-term route of the mobile body via the surrounding posture of the surrounding posture surrounding terrain having the reliability highest among the surrounding posture surrounding terrains which are the surrounding terrains estimated on the basis of the plurality of surrounding posture observation three-dimensional terrains, and controls the movement of the mobile body on the basis of the short-term route planned.

<14> The information processing apparatus according to any one of <1> to <13>, in which
the surrounding posture observation three-dimensional terrain estimation unit and the surrounding terrain estimation unit are both neural networks, and are formed by machine learning.

<15> The information processing apparatus according to any one of <1> to <14>, in which
the surrounding terrain estimation unit estimates the surrounding terrain by complementing missing portions of the initial posture observation three-dimensional terrain and a plurality of the surrounding posture observation three-dimensional terrains.

<16> The information processing apparatus according to any one of <1> to <15>, in which
the sensor includes at least one of a camera, a radar, a LiDAR (Light Detection and Ranging, Laser Imaging Detection and Ranging), or an ultrasonic sensor.

<17> The information processing apparatus according to <16>, in which
the camera includes at least one of a time of flight (ToF) camera, a stereo camera, a monocular camera, or an infrared camera.

<18> An information processing method including the steps of:
estimating a plurality of surrounding posture observation three-dimensional terrains around a mobile body detected by a sensor of the mobile body in a plurality of surrounding postures in which at least one of a position or a direction is different by a predetermined value from an initial posture on the basis of an initial posture observation three-dimensional terrain around the mobile body detected by the sensor of the mobile body in the initial posture;
estimating a terrain around the mobile body as a surrounding terrain on the basis of the initial posture observation three-dimensional terrain and each of the plurality of surrounding posture observation three-dimensional terrains; and
planning a route and a posture of the mobile body and controlling movement on the basis of the surrounding terrain estimated.

<19> A program causing a computer to function as:
a surrounding posture observation three-dimensional terrain estimation unit that estimates a plurality of surrounding posture observation three-dimensional terrains around a mobile body detected by a sensor of the mobile body in a plurality of surrounding postures in which at least one of a position or a direction is different by a predetermined value from an initial posture on the basis of an initial posture observation three-dimensional terrain around the mobile body detected by the Sensor of the mobile body in the initial posture;
a surrounding terrain estimation unit that estimates a terrain around the mobile body as a surrounding terrain on the basis of the initial posture observation three-dimensional terrain and each of the plurality of surrounding posture
observation three-dimensional terrains; and a control unit that plans a route and a posture of the mobile body and controls movement on the basis of the surrounding terrain estimated by the surrounding terrain estimation unit.

### REFERENCE SIGNS LIST

31 Mobile body
51, 51-1 to 51-n Sensor
52 Drive control unit
53 Drive unit
54 Display unit
55 Operation unit
71 3D model construction unit
72 Self-position estimation unit
73, 73-1 to 73-n Data processing unit
74 Data integration unit
75 Inference unit
76 UI generation unit
77 Route planning unit
78 Drive control unit
91 Surrounding posture observation 3D terrain estimation unit
92 Surrounding terrain estimation unit

1. An information processing apparatus comprising:
a surrounding posture observation three-dimensional terrain estimation unit that estimates a plurality of surrounding posture observation three-dimensional terrains around a mobile body detected by a sensor of the mobile body in a plurality of surrounding postures in which at least one of a position or a direction is different by a predetermined value from an initial posture on a basis of an initial posture observation three-dimensional terrain around the mobile body detected by the Sensor of the mobile body in the initial posture;
a surrounding terrain estimation unit that estimates a terrain around the mobile body as a surrounding terrain on a basis of the initial posture observation three-dimensional terrain and each of the plurality of surrounding posture observation three-dimensional terrains; and
a control unit that plans a route and a posture of the mobile body and controls movement on a basis of the surrounding terrain estimated by the surrounding terrain estimation unit.

2. The information processing apparatus according to claim 1, wherein
the surrounding terrain estimation unit estimates the terrain around the mobile body as the surrounding terrain and calculates reliability of each surrounding terrain on a basis of the initial posture observation three-dimensional terrain and each of the plurality of surrounding posture observation three-dimensional terrains.

3. The information processing apparatus according to claim 2, wherein
in a case where the reliability of an initial posture surrounding terrain estimated on a basis of the initial posture observation three-dimensional terrain among the surrounding terrains estimated by the surrounding terrain estimation unit is higher than a predetermined value, the control unit plans the route and the posture of the mobile body on a basis of the initial posture surrounding terrain and starts autonomous movement.

4. The information processing apparatus according to claim 2, wherein
in a case where the reliability of an initial posture surrounding terrain estimated on a basis of the initial posture observation three-dimensional terrain among the surrounding terrains estimated by the surrounding terrain estimation unit is lower than a predetermined value, the control unit plans the route and the posture of the mobile body and controls movement on a basis of a surrounding posture surrounding terrain which is the surrounding terrain estimated on a basis of the plurality of surrounding posture observation three-dimensional terrains.

5. The information processing apparatus according to claim 4, further comprising
a user interface (UI) generation unit that presents, as a candidate, the surrounding posture in which the reliability of the surrounding posture surrounding terrain estimated is high, and generate a UI image prompting selection of any one of the candidates, wherein
the control unit plans the route and the posture of the mobile body and controls movement to take a position and a posture corresponding to the surrounding posture as the candidate selected among the surrounding postures presented as the candidates in the UI image.

6. The information processing apparatus according to claim 5, wherein
after the control unit plans the route and the posture of the mobile body and controls movement to take the position and the posture corresponding to the surrounding posture as the candidate selected among the surrounding postures presented as the candidates in the UI image,
the surrounding posture observation three-dimensional terrain estimation unit regards the surrounding posture as the candidate selected as a new initial posture, and estimates a plurality of new surrounding posture observation three-dimensional terrains on a basis of an initial posture observation three-dimensional terrain in the new initial posture,
the surrounding terrain estimation unit estimates the surrounding terrain from each of the initial posture observation three-dimensional terrain being new and the plurality of new surrounding posture observation three-dimensional terrains, and
the control unit repeats similar processing until it is determined that the reliability of the initial posture surrounding terrain estimated on a basis of the initial posture observation three-dimensional terrain among the surrounding terrains estimated by the surrounding terrain estimation unit is higher than a predetermined value.

7. The information processing apparatus according to claim 5, wherein
the UI image presents, as the candidate, the surrounding posture in which the reliability of the surrounding posture surrounding terrain estimated is high together with information indicating the reliability.

8. The information processing apparatus according to claim 7, wherein
the UI image presents, as the candidate, the surrounding posture in which the reliability of the surrounding posture surrounding terrain estimated is high together with information colored corresponding to the reliability.

9. The information processing apparatus according to claim 5, wherein
when a pointer is moved to a position where the surrounding posture is presented as the candidate in the UI image, the UI generation unit generates and displays the UI image based on the surrounding posture surrounding terrain estimated when the mobile body moves to the surrounding posture where the pointer is located.

10. The information processing apparatus according to claim 5, wherein
in a case where it is not possible to move the mobile body to take the position and the posture corresponding to the surrounding posture as the candidate selected among the surrounding postures presented in the UI image, the control unit excludes information of the surrounding posture selected from the candidates.

11. The information processing apparatus according to claim 2, wherein
in a case where the reliability of an initial posture surrounding terrain estimated on a basis of the initial posture observation three-dimensional terrain is lower than a predetermined value among the surrounding terrains estimated by the surrounding terrain estimation unit, the control unit plans the route and the posture of the mobile body and controls movement on a basis of the surrounding posture in which the reliability of a surrounding posture surrounding terrain that is the surrounding terrain estimated on a basis of the plurality of surrounding posture observation three-dimensional terrains is highest.

12. The information processing apparatus according to claim 3, wherein
in a case where the reliability of the initial posture surrounding terrain estimated on a basis of the initial posture observation three-dimensional terrain among the surrounding terrains estimated by the surrounding terrain estimation unit is higher than a predetermined value after the route and the posture of the mobile body are planned on a basis of the initial posture surrounding terrain and the autonomous movement is started, the control unit plans a long-term route of the mobile body starting from the initial posture on a basis of the initial posture surrounding terrain, and controls the movement of the mobile body on a basis of the long-term route planned.

13. The information processing apparatus according to claim 3, wherein
in a case where the reliability of the initial posture surrounding terrain estimated on a basis of the initial posture observation three-dimensional terrain among the surrounding terrains estimated by the surrounding terrain estimation unit is lower than a predetermined value after the route and the posture of the mobile body are planned on a basis of the initial posture surrounding terrain and the autonomous movement is started, the control unit plans a short-term route of the mobile body via the surrounding posture of the surrounding posture surrounding terrain having the reliability highest among the surrounding posture surrounding terrains which are the surrounding terrains estimated on a basis of the plurality of surrounding posture observation three-dimensional terrains, and controls the movement of the mobile body on a basis of the short-term route planned.

14. The information processing apparatus according to claim 1, wherein
the surrounding posture observation three-dimensional terrain estimation unit and the surrounding terrain estimation unit are both neural networks, and are formed by machine learning.

15. The information processing apparatus according to claim 1, wherein
the surrounding terrain estimation unit estimates the surrounding terrain by complementing missing portions of the initial posture observation three-dimensional terrain and a plurality of the surrounding posture observation three-dimensional terrains.

16. The information processing apparatus according to claim 1, wherein
the sensor includes at least one of a camera, a radar, a LiDAR (Light Detection and Ranging, Laser Imaging Detection and Ranging), or an ultrasonic sensor.

17. The information processing apparatus according to claim 16, wherein
the camera includes at least one of a time of flight (ToF) camera, a stereo camera, a monocular camera, or an infrared camera.

18. An information processing method comprising the steps of:
estimating a plurality of surrounding posture observation three-dimensional terrains around a mobile body detected by a sensor of the mobile body in a plurality of surrounding postures in which at least one of a position or a direction is different by a predetermined value from an initial posture on a basis of an initial posture observation three-dimensional terrain around the mobile body detected by the sensor of the mobile body in the initial posture;
estimating a terrain around the mobile body as a surrounding terrain on a basis of the initial posture observation three-dimensional terrain and each of the plurality of surrounding posture observation three-dimensional terrains; and
planning a route and a posture of the mobile body and controlling movement on a basis of the surrounding terrain estimated.

19. A program causing a computer to function as:
a surrounding posture observation three-dimensional terrain estimation unit that estimates a plurality of surrounding posture observation three-dimensional terrains around a mobile body detected by a sensor of the mobile body in a plurality of surrounding postures in which at least one of a position or a direction is different by a predetermined value from an initial posture on a basis of an initial posture observation three-dimensional terrain around the mobile body detected by the sensor of the mobile body in the initial posture;
a surrounding terrain estimation unit that estimates a terrain around the mobile body as a surrounding terrain on a basis of the initial posture observation three-dimensional terrain and each of the plurality of surrounding posture observation three-dimensional terrains; and
a control unit that plans a route and a posture of the mobile body and controls movement on a basis of the surrounding terrain estimated by the surrounding terrain estimation unit.
